(19) United States
(12) Patent Application Publication
(10) Pub. No.: US 2010/0141840 A1
(43) Pub. Date: Jun. 10, 2010

(54) Method and Apparatus for Combining Media From Multiple Sources for Display and Viewer Interaction

(76) Inventors: Robert Charles Angell, Kent County, RI (US); Ian Mitchell, Newport County, RI (US)

Correspondence Address: RYAN, MASON & LEWIS, LLP, 1300 POST ROAD, SUITE 205, FAIRFIELD, CT, 06824, US

(21) Appl. No.: 12/532,961

(22) PCT Filed: Mar. 28, 2008
(86) PCT No.: PCT/US08/58552

§ 371 Date: Feb. 19, 2010

Related U.S. Application Data
(60) Provisional application No. 60/909,125, filed on Mar. 30, 2007.

(51) Int. Cl. H04N 5/445; H04N 5/91

(52) U.S. Cl. 348/564; 386/95; 725/61; 348/E05.099; 386/E05.003

(57) ABSTRACT

Methods and apparatus are provided for combining media from multiple sources for display and viewer interaction The disclosed Multi-Media Overlay System provides a mechanism and a process for consumers to combine media from various sources to create the appearance of a single media The Multi-Media Overlay System applies “overlay content,” such as text, images, and interaction to some “primary content,” such as a DVD movie The timing, location, and presentation of the overlay content are developed with the primary content in mind. The Multi-Media Overlay System comprises a device that accepts media from various sources and allows the execution of a Primary Software Application to perform the overlay function, allows user interaction with the generated content, and displays the generated content.

### CROSS-REFERENCE TO RELATED APPLICATIONS

This application claims the benefit of U.S. Provisional Application No. 60/909,125, filed Mar. 30, 2007, and is related to United States Provisional patent applications entitled “Methods and Apparatus for Distributing Electronic Media Content for the Purpose of Enhancing Existing Media” and “Methods and Apparatus for Simplifying the Creation and Editing of Media Intended for the Enhancement of Consumer Media,’ each incorporated by reference herein.

### FIELD OF THE INVENTION

The present invention relates to the coordinated display of and interaction of various media types from various sources

### BACKGROUND OF THE INVENTION

There are an ever-increasing number of sources and types of electronic media as various technologies advance. Types of electronic media include, but are not limited to, text, image, animations, movies of various formats, games and interactive applications. Sources of electronic media include optically recorded media (such as CD, DVD, HD DVD and Blue-Ray), the Internet, magnetic storage devices and electronic storage devices. Other than the limited abilities of the Personal Computer in this area, there are few choices available to consumers to effectively combine or overlay multiple media sources for enhanced viewing. A need therefore exists for a Multi-Media Overlay System (MMOS) that allows a user to combine or overlay various media types from various media sources into a single viewable and interactive presentation on their television.

### SUMMARY OF THE INVENTION

Generally, methods and apparatus are provided for combining media from multiple sources for display and viewer interaction. According to one aspect of the invention, the disclosed MMOS provides a mechanism and a process for consumers to combine media from various sources to create the appearance of a single media. For this description, the final result of the overlay process will be referred to as the “MMOSed content”. MMOSed content is the result of applying “overlay content,” such as text, images, and interaction to some “primary content,” such as a DVD movie. The timing, location, and presentation of the overlay content are developed with the primary content in mind.

The disclosed MMOS comprises a device that accepts media from various sources and allows the execution of a Primary Software Application (PSA) to perform the overlay function, allows user interaction with the MMOSed content, and displays the MMOSed content. The PSA will allow the execution of “overlay software” developed specifically for the overlaying of a certain combination of media (such as a specific text-based trivia game designed for a specific movie DVD). The MMOS will also allow user interaction through a remote control. This interaction will control the physical MMOS device and provide interaction with the MMOSed content via the PSA.

Advantages of the present invention include the enhancement of media that a user may purchase or has previously purchased. Further, these enhancements can be updated by the MMOS content provider and obtained by the users. Overlay content can be input to the device, for example, via the Internet, electronic storage, optical storage, or personal computer. The device can also automatically check for overlay content updates on the Internet. The device will output video and audio to various display types. In this manner, content providers can give consumers added value to their media in the form of games, applications, amplifying information and on-line communities. It will also allow content providers to offer additional marketing-related information to consumers.

A more complete understanding of the present invention, as well as further features and advantages of the present invention, will be obtained by reference to the following detailed description and drawings.

### BRIEF DESCRIPTION OF THE DRAWINGS

FIG. 1 is a block diagram of the Multi-Media Overlay System in accordance with an embodiment of the present invention;

FIG. 2 is a flow diagram representing the user interaction with a MMOS and the execution of MMOSed content; and

FIG. 3 is a sample table from an exemplary multi-media overlay index incorporating features of the present invention.

### DETAILED DESCRIPTION

Detailed embodiments of the present invention are disclosed herein, however, it is to be understood that the disclosed embodiments are merely exemplary of the invention, which may be embodied in various forms. Therefore, specific functional or structural details disclosed herein are not to be interpreted as limiting, but merely as a basis for the claims and as a representative basis for teaching one skilled in the art to variously employ the present invention in virtually any appropriately detailed embodiment.

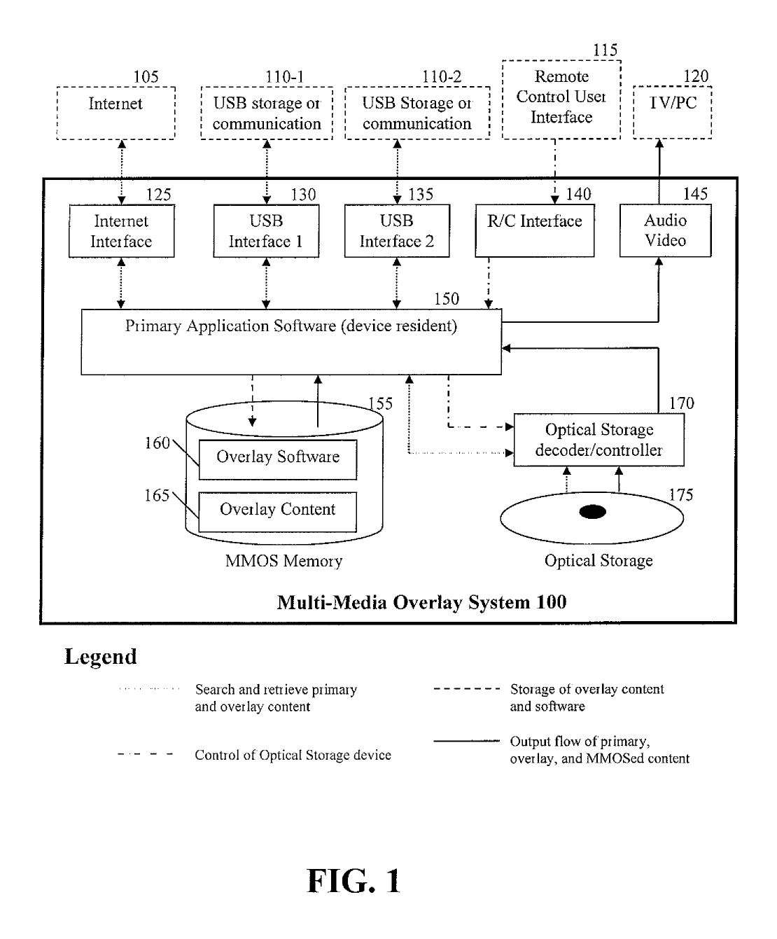

Turning now to FIG. 1, a block diagram of an exemplary embodiment of a Multi-Media Overlay System 100 in accordance with the present invention is shown. A Multi-Media Overlay System 100 is a physical device with various interfaces to potential sources of digital content. The block diagram of FIG. 1 shows these exemplary digital media interfaces as an Internet connection 105, two exemplary USB connections 110-1 and 110-2 (each of which would accept connections from USB devices, such as computers and storage devices), and a optical storage device 175. FIG. 1 also shows the device-resident software component 155 and the device memory 155 which will store the specific Overlay Content 160 and its associated specific Overlay Software 165.

FIG. 1 further shows the Optical Storage Decoder/Controller 170 and its interface to the Primary Application Software 150. An interface to support user interaction is shown as the Remote Control User Interface 140 which will allow a user to interact with the MMOSed content with a remote control 115 that may be similar, for example, to current DVD and/or game controllers. Finally, the output of the MMOSed content is shown via the Video/Audio output block 145 to a television 120, computer or another presentation device. It is noted that the present invention can be implemented as a set-top terminal or a similar device at the user location, or may be implemented centrally, for example, by a service provider that combines the primary content and supplemental content prior to distributing the content to the end-user.

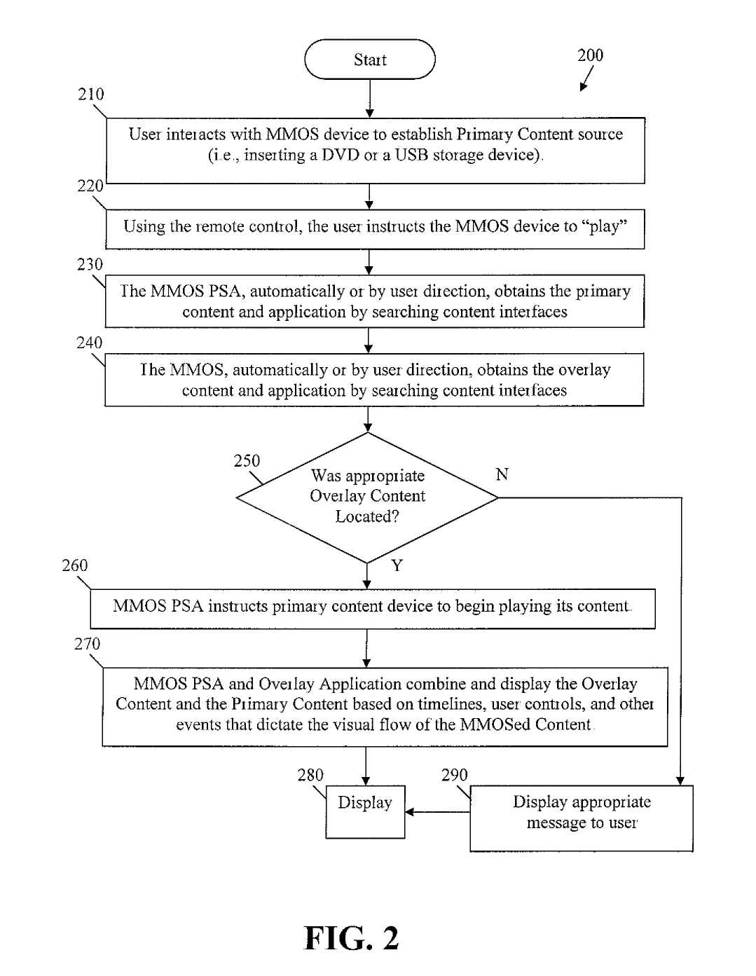

FIG. 2 is a flow diagram 200 representing the user interaction with a MMOS and the execution of MMOSed content. FIG. 2 depicts the method of operation of an exemplary implementation of the MMOS relative to retrieving, generating, interacting with, and displaying MMOSed content. To initiate the MMOS, a user specifies the location of the Primary Content during step 210. For example, the user can insert a DVD or a USB Storage Device or can connect a computer via a USB interface, or can instruct the MMOS (e.g., via the remote control) to access the Internet. The user will then select “Play” on the remote control during step 220 to initiate the “MMOSing” of the content.

During step 230, the Primary Content is located and/or downloaded. The MMOS will then locate and download the Overlay Application and Overlay Content specific to the Primary Content during step 240. This can be accomplished, for example, by 1) the user specifying the location (e.g., via the remote control), 2) automatically searching the various content interfaces for the appropriate data, or 3) the location being specified as part of the data found with the Primary Content. The user will be notified when the Primary Content and the Overlay Content and Overlay Application have been located/downloaded.

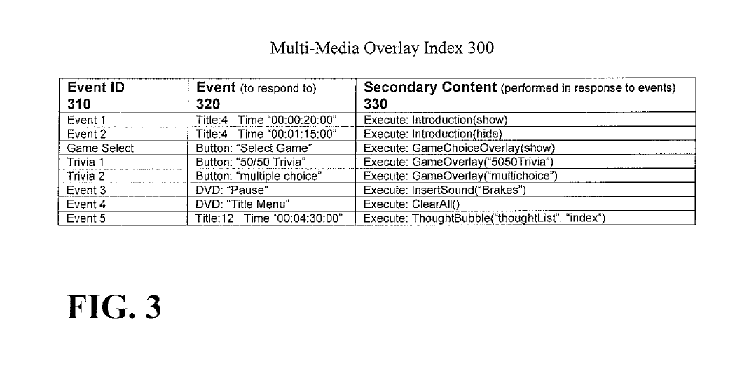

Once the appropriate Overlay Content is located during step 250, the MMOS Primary Software Application (PSA) instructs the primary content device to begin playing its content during step 260. The PSA will execute the Overlay Application. The Overlay Application contains information about what type of Overlay Content to apply to the Primary Content based on timing and other events of the Primary Content (as discussed further below in conjunction with FIG. 3) and based on user inter action via the remote control. The PSA will monitor the events of the Primary Content through the appropriate mechanism (i.e., the Optical Storage decoder/controller) as well as the remote control to determine when to apply the appropriate Overlay Content. The PSA will send the appropriate audio and video Overlay Content to the display device during step 280 while the Primary Content has its audio and video streamed to the display device.

If the appropriate Overlay Content is not located during step 250, an appropriate error message can be presented to the user during step 290.

FIG. 3 is a sample table from an exemplary multi-media overlay index 300 incorporating features of the present invention. As shown in FIG. 3, the exemplary multi-media overlay index 300 is associated with a particular primary content item, such as a particular movie or a particular episode of a television show. The exemplary multi-media overlay index 300 comprises a plurality of records, each associated with a different event in the primary content or each event identified in field 310, the exemplary multi-media overlay index 300 defines the event in the field 320 and identifies the secondary content associated with the event in field 330.

The exemplary multi-media overlay index 300 allows particular secondary content to be associated with desired times or events in the primary content. Examples of secondary content include trivial pursuit type interaction, graphic overlays, additional sound and interactive games.

While FIG. 2 shows an exemplary sequence of steps, it is also an embodiment of the present invention that the sequence may be varied. Various permutations of the algorithm are contemplated as alternate embodiments of the invention

While exemplary embodiments of the present invention have been described with respect to processing steps in a software program, as would be apparent to one skilled in the art, various functions may be implemented in the digital domain as processing steps in a software program, in hardware by circuit elements or state machines, or in combination of both software and hardware Such software may be employed in, for example, a digital signal processor, micro-controller, or general-purpose computer. Such hardware and software may be embodied within circuits implemented within an integrated circuit.

Thus, the functions of the present invention can be embodied in the form of methods and apparatuses for practicing those methods. One or more aspects of the present invention can be embodied in the form of program code, for example, whether stored in a storage medium, loaded into and/or executed by a machine, or transmitted over some transmission medium, wherein, when the program code is loaded into and executed by a machine, such as a computer, the machine becomes an apparatus for practicing the invention. When implemented on a general-purpose processor, the program code segments combine with the processor to provide a device that operates analogously to specific logic circuits. The invention can also be implemented in one or more of an integrated circuit, a digital signal processor, a microprocessor, and a micro-controller.

System and Article of Manufacture Details

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, memory cards, semiconductor devices, chips, application specific integrated circuits (ASICs)) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc do not denote any order or importance, but rather the terms first, second, etc are used to distinguish one element from another.

What is claimed is:

1. An apparatus, comprising:
a memory; and
at least one processor, coupled to the memory, operative to:
obtain primary content for presentation to a user on a television;
obtain supplemental content related to said primary content;
obtain an overlay index that associates said supplemental content with one or more times or events in said primary content; and
present a combination of said primary content and said supplemental content based on said overlay index on said television.

2. The apparatus of claim 1, wherein said primary content is obtained from one or more of a CD, DVD or streaming media connection.

3. The apparatus of claim 1, wherein said supplemental content is presented to said user based on or more of a schedule, a timeline, user control actions and events in said primary content.

4. The apparatus of claim 1, wherein said supplemental content is presented to said user based on links to said primary content.

5. The apparatus of claim 1, wherein said supplemental content is overlayed on said primary content.

6. The apparatus of claim 1, further comprising an interface to allow said user to interact with said supplemental content.

7. A method for presenting content to a user, comprising:
obtaining primary content for presentation to said user on a television;
obtaining supplemental content related to said primary content;
obtaining an overlay index that associates said supplemental content with one or more times or events in said primary content; and
presenting a combination of said primary content and said supplemental content based on said overlay index on said television.

8. The method of claim 7, wherein said primary content is obtained from one or more of a CD, DVD or streaming media connection

9. The method of claim 7, wherein said supplemental content is presented to said user based on or more of a schedule, a timeline, user control actions and events in said primary content.

10. The method of claim 7, wherein said supplemental content is presented to said user based on links to said primary content.

11. The method of claim 7, wherein said supplemental content is overlayed on said primary content.

12. The method of claim 7, further comprising an interface to allow said user to interact with said supplemental content.

13. An article of manufacture for presenting content to a user, comprising a machine readable storage medium containing one or more programs which when executed implement the steps of:
obtaining primary content for presentation to said user on a television;
obtaining supplemental content related to said primary content;
obtaining an overlay index that associates said supplemental content with one or more times or events in said primary content; and
presenting a combination of said primary content and said supplemental content based on said overlay index on said television.

14. The article of manufacture of claim 13, wherein said primary content is obtained from one or more of a CD, DVD or streaming media connection.

15. The article of manufacture of claim 13, wherein said supplemental content is presented to said user based on or more of a schedule, a timeline, user control actions and events in said primary content.

16. The article of manufacture of claim 13, wherein said supplemental content is presented to said user based on links to said primary content.

17. The article of manufacture of claim 13, wherein said supplemental content is overlayed on said primary content.

18. The article of manufacture of claim 13, further comprising an interface to allow said user to interact with said supplemental content.
